(19) United States
(12) Patent Application Publication
(10) Pub. No.: US 2017/0106413 A1
(43) Pub. Date: Apr. 20, 2017

(54) METHODS AND APPARATUS TO CLEAN AND DRY CAVITIES

(71) Applicant: Dürr Ecoclean GmbH, Filderstadt (DE)

(72) Inventors: Hermann-Josef DAVID, Monschau (DE); Alexander GENZE, Simmerath (DE); Egon KÄSKE, Aachen (DE)

(21) Appl. No.: 15/395,433

(22) Filed: Dec. 30, 2016

Related U.S. Application Data
(63) Continuation-in-part of application No. PCT/EP2015/064908, filed on Jun. 30, 2015.

(30) Foreign Application Priority Data
Jul. 4, 2014 (DE) 102014213089

(51) Int. Cl. B08B 9/035; B23Q 11/00; B08B 9/032

(52) U.S. Cl. CPC B08B 9/035; B08B 9/0328; B23Q 11/0075; B23Q 11/006

(57) ABSTRACT

Methods and apparatus to clean and dry cavities are disclosed. A disclosed example tool apparatus includes an inner tube to provide a fluid to the cavity when the tool apparatus is positioned relative to the cavity, and an annular tube surrounding the inner tube, where the annular tube is fluidly coupled to a suction chamber and where the suction chamber is fluidly coupled to a vacuum vessel. The example tool apparatus also includes a valve disposed between the suction chamber and the vacuum vessel.

### RELATED APPLICATION

This patent arises as a continuation-in-part of International Patent Application No. PCT/EP2015/064908, which was filed on Jun. 30, 2015, which claims priority to German Patent Application No. 10 2014 213 089, which was filed on Jul. 4, 2014. The foregoing International Patent Application and German Patent Application are hereby incorporated herein by reference in their entireties.

### FIELD OF THE DISCLOSURE

This disclosure relates generally to industrial production processes, and, more particularly, to methods and apparatus to clean and dry cavities.

### BACKGROUND

During machining of workpieces such as engine components (e.g., cylinder heads), cooling lubricants are employed, thereby resulting in the creation of chips. Thus, workpieces are contaminated because of these created chips. Instances of such contamination may cause disruptions in downstream assembly processes, thereby compromising the technical functionality of such systems that are manufactured from respective workpieces. Contamination from cooling lubricants and chips in cylinder-head bores as well as injection nozzles may cause irreparable engine damage in examples related to internal combustion engines.

### BRIEF DESCRIPTION OF THE DRAWINGS

FIG. 1 shows an example device for cleaning and/or drying a cavity using a first example cleaning tool.

FIG. 2 shows an example device for cleaning and/or drying a cavity using a second example cleaning tool.

FIGS. 3-6 show additional example cleaning tools for a device for cleaning and/or drying a cavity.

The figures are not to scale. Instead, to clarify multiple layers and regions, the thickness of the layers may be enlarged in the drawings. Wherever possible, the same reference numbers will be used throughout the drawing(s) and accompanying written description to refer to the same or like parts. As used in this patent, stating that any part is in any way positioned on (e.g., positioned on, located on, disposed on, or formed on, etc.) another part, means that the referenced part is either in contact with the other part, or that the referenced part is above the other part with one or more intermediate part(s) located therebetween. Stating that any part is in contact with another part means that there is no intermediate part between the two parts.

### DETAILED DESCRIPTION

Methods and apparatus to clean and dry cavities are disclosed. The examples disclosed herein relate to a device for cleaning and/or drying a cavity, such as a clearance in a workpiece (e.g., a bore, a threaded bore), which is accessible through an opening.

A known device of the aforementioned type for cleaning and/or drying is shown in DE 103 18 238 B4, which is hereby incorporated by reference. This known device includes a cleaning tool to clean internal faces of threaded bores in a workpiece, where the cleaning tool has a lance-shaped blower insert, which may be introduced into a threaded bore. An infeed duct for a cleaning medium such as, for example, blown air, is implemented in the blower insert. The infeed duct has a slot-shaped opening that extends along a longitudinal direction on the blower insert. The slot-shaped opening tangentially guides an incident flow of a cleaning medium directly onto the wall of a threaded bore. The thread pitches in the threaded bore may, thus, be relieved of dirt particles.

When blowing down threaded bores of a small diameter, relatively large dirt particles often cannot escape from the bore because these larger dirt particles congest the flow path for discharging the dirt particles. Further, back pressure may be generated in the clearances when blown air is provided/injected in a targeted manner into clearances of workpieces, where the back pressure limits the effective depth for cleaning. Moreover, when cleaning and/or drying clearances in a workpiece using blow air, there can be a problem with liquids such as, for example, oils and cooling lubricants, which are received in the cavities while being finely atomized. As a result, aerosols that may be hazardous to health can be created. There beyond, cleaning and/or drying workpieces using blow air may also be costly because a relatively large amount of energy is required to provide the blown air.

It is an object of the examples disclosed herein to improve cleaning and/or drying of cavities in workpieces, which are accessible through an opening, during industrial production.

This object can be achieved by a device for cleaning and/or drying a cavity that is accessible through an opening, which includes an installation for extracting by suction, and a cleaning tool having a suction chamber that is couplable (e.g., connectable, fluidly coupled) to the installation for extracting by suction, and has a suction opening to extract, via suction, a medium from the cavity.

It can, thus, be achieved that dirt particles and liquids that have accumulated in a clearance of workpieces are not released into the environment during cleaning and/or drying.

In particular, it is a concept of the examples disclosed herein that a tubular element that has a tubular-element portion, which is disposed in the suction chamber, is provided in the example of the cleaning tool. In such examples, a fluid duct for infeeding a cleaning medium that is provided at an entry opening outside of the suction chamber is implemented and/or configured in the tubular element.

In some examples, since the tubular element is routed through the workpiece-side suction opening of the suction chamber, even deep clearances in workpieces may be cleaned using such example devices. In such examples, the tubular element may be implemented/configured as an immersion pipe that is introducible into the cavity through the opening. In particular, the immersion pipe may be length-adjustable, for example.

In particular, it is a concept of the examples disclosed herein that the installation for extracting by suction includes a vacuum vessel that is evacuatable by a vacuum pump, and a fluid line that connects the vacuum vessel to the suction chamber and in which a shut-off member to shut off the fluid line is disposed to selectively connect/couple the vacuum vessel to the suction chamber or to separate the vacuum vessel therefrom. It is possible in this manner for the cavity of the workpiece and/or clearances of the workpiece to be impinged with negative pressure in the magnitude of 1 bar below atmospheric pressure, and to, thus, cause increased and/or maximum pressure differentials between the cavity of the workpiece and the workpiece environment, for example, thereby resulting in relatively intense fluid flows through the tubular element into the cavity of the workpiece and, subsequently, into the suction chamber.

The shut-off member for shutting off the fluid line coupling/connecting the vacuum vessel to the suction chamber can, preferably, be implemented as a rapid-action switch valve (e.g., an electrically or pneumatically or hydraulically actuated gate, an electrically or pneumatically or hydraulically actuated flap, a coaxial valve, etc.) that may be actuated electrically or pneumatically or hydraulically, for example. In this manner, it is possible for the cavity of the workpiece to be impinged in a pulsated manner with negative pressure and to, thus, result in relatively large pressure differentials between the cavity of the workpiece and the workpiece environment with little and/or minimal delay, thereby resulting in relatively intense fluid flows through the tubular element into the cavity of the workpiece and into the suction chamber.

In some examples, since the fluid duct has a funnel-shaped port section, it may be achieved on the device for cleaning and/or drying a cavity that is accessible through an opening that an inflow cone to reduce and/or minimize the inflow resistance to the gaseous fluid that is suctioned in through the tubular element when the suction chamber is impinged with negative pressure.

It is also a concept of the examples disclosed herein that the cleaning tool has a connector portion for engaging across the opening of the cavity in the manner of a suction cup.

The suction chamber may also be implemented in a tool element that in the application portion of the cleaning tool includes a workpiece-side end face that has an end-face plane and faces a workpiece having a cavity to be cleaned and/or dried. The tubular element in such examples, preferably, includes a workpiece-side end that lies in the end-face plane or which, in relation to the end-face plane, is disposed to be recessed.

In particular, in some examples, the cup-shaped connector portion may have a sealing means that enables the suction chamber on the workpiece side to be sealed via a seal that surrounds the opening when the connector portion is placed against the opening of the cavity. The sealing means in such examples may be a sealing element that is received on the connector portion. This sealing element may, in particular, be elastic and/or flexible, for example. Additionally or alternatively, the sealing element may be a bellows, for example.

It is of advantage for the suction chamber to be implemented as a cylindrical cavity that is elongate along the direction of a cylinder axis. The tubular element then, preferably, includes a tube axis that is aligned with the cylinder axis. The tubular-element portion in the suction chamber may be bent in a relatively arcuate manner. In some examples, the entry opening may be implemented and/or disposed on a side of the suction chamber that is opposite the workpiece-side suction opening.

The examples disclosed herein also extend to a method for cleaning and/or drying a cavity, such as a clearance in a workpiece (e.g., a bore, a threaded bore, etc.), which is accessible through an opening. In such examples, the cavity is extracted by suction through the opening, and the latter, simultaneously during extraction by suction, is provided/infed a cleaning fluid. Preferably, in some examples, this cleaning fluid is provided to the cavity with a coaxial fluid flow relative to the flow of the fluid being extracted by suction from the cavity. In some particularly preferable examples, the cleaning fluid relative to the axis of the fluid flow of the fluid that is extracted by suction from the cavity is provided through the opening of the cavity to the cavity in a relatively axis-proximal/proximate manner, for example. In such examples, the cleaning fluid may be provided via a tubular element that protrudes into the cavity. However, alternatively, in some examples, the cleaning fluid is to be provided through a tubular element that is disposed outside the cavity.

In particular, it is a concept of the examples disclosed herein that the cavity is extracted via suction through the opening using a cleaning tool that includes a suction chamber, which is coupled to an installation for extracting by suction through which the dirt particles and/or the liquid are routed from the cavity that is accessible through the opening to the installation for extracting by suction. For the workpiece-side sealing of the suction chamber, the cleaning tool of such examples may bear and/or contact in a relatively sealing manner to the workpiece. Alternatively, in some examples, it is possible for the cleaning tool during extraction via suction to be separated from the workpiece by an air space. In some examples, the workpiece during this extraction by suction is not in contact with the cleaning tool. In some examples, for the workpiece-side sealing of the suction chamber, the cleaning tool may contact and/or bear in a relatively sealing manner to the workpiece. However, in some examples, the cleaning tool during extraction by suction may also be separated from the workpiece by only an air space.

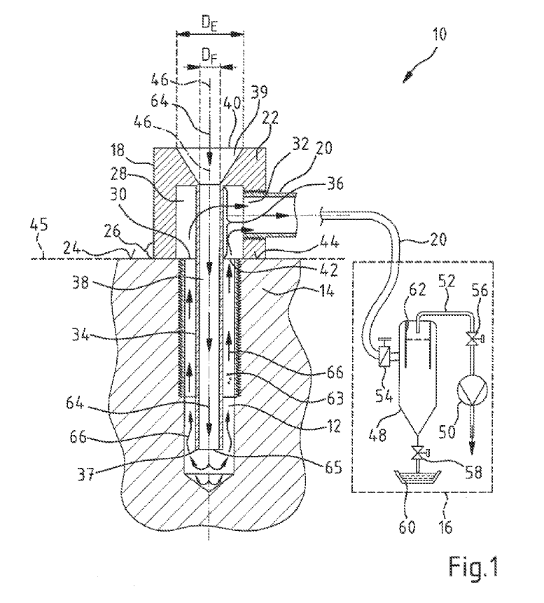

Turning to FIG. 1, the example device 10 is implemented to clean and/or dry a cavity that is a threaded bore 12 of a workpiece 14. According to the illustrated example, the device 10 includes an installation 16 for extracting by suction, and has a cleaning tool 18. The cleaning tool 18, by way of a pressure-tight fluid line 20, is coupled/connected to the installation 16 for extracting by suction.

The cleaning tool 18 of the illustrated example includes a tool element 22 with a connector portion 26 that is capable of being brought to bear on and/or contact the surface 24 of the workpiece 14. In this example, a cylindrical suction chamber 28, which has a workpiece-side suction opening 30 for extracting by suction a medium from the threaded bore 12 that is disposed in the application portion 26, is implemented in the tool element 22.

The cleaning tool 18 of the illustrated example has a tubular element 34, which has a tubular-element portion 36 that is disposed in the suction chamber 28. In the tubular element 34, there is a fluid duct 38 to provide/infeed cleaning fluid such as ambient air, for example, into the threaded bore 12. The example fluid duct 38 includes an entry opening 40 that is disposed outside of the suction chamber 28 and at which the ambient air is provided at approximately the atmospheric pressure of pat≈1000 millibar (mbar), for example. In this example, the fluid duct 38 opens toward the entry opening 40 in a relatively funnel-shaped manner. The tubular element 34 is routed through the workpiece-side suction opening 30 of the suction chamber 28 and is implemented as an immersion pipe, which is introducible/movable into the threaded bore 12 and includes an end-side end 37 as well as a workpiece-side exit opening 65.

In a modified example of the cleaning tool 18, the tubular element 34 may be length-adjustable, for example. In particular, the tubular element 34 may have a telescopic mechanism, for example, which has a first tubular-element portion and a second tubular-element portion, where the second tubular-element portion is guided in a linearly movable manner relative to the first tubular-element portion.

According to the illustrated example, the application portion 26 of the cleaning tool 18 is implemented as annular and/or generally annular-shaped. The element 22 of the cleaning tool 18 including the suction chamber 28 implemented therein, thus, in the manner similar to a suction cup, for example, engages across the opening 42 of the threaded bore 12. As a result, the element 22, by way of a workpiece-side end face 44 that acts as a connector face, bears in a relatively sealing manner onto/to the surface 24 of the workpiece 14. In this example, the suction chamber 28 is implemented as a substantially cylindrical cavity that is elongate and/or extends generally along the direction of a cylinder axis 46. In some examples, the tubular element 34 has a tubular-element portion 36 that is elongate along a tubular element axis that is substantially aligned with the cylinder axis 46.

By way of an extraction opening 32, the suction chamber 28 of the illustrated example is coupled (e.g., fluidly coupled) to the installation 16 to extract via suction. The example installation 16 includes a vacuum vessel 48 that is coupled to the negative-pressure tight fluid line 20. In this example, a vacuum pump 50 for evacuating the vacuum vessel 48 is positioned in the installation 16. The vacuum pump 50, by way of a pressure-tight fluid line 52, is coupled to the vacuum vessel 48. According to the illustrated example, the installation 16 has, as a shut-off member 54, a rapid-action shut-off valve that is disposed in the fluid line 20 by which the fluid line 20 may be enabled or disabled. A shut-off valve 56, by which the vacuum pump 50 may be separated at short switching delays (e.g., Δt≦1 second (s), preferably Δt+≦0.1 s from when the vacuum vessel 48), is disposed in the fluid line 52. In this example, the vacuum vessel 48 includes an outlet valve 58 that ventilates the vacuum vessel 48 on demand, and directs dirt particles as well as condensate that have accumulated in the vacuum vessel 48 into a receptacle container 60 for disposal. The vacuum vessel 48 of the illustrated example includes a dirt trap 62 that precludes, prevents and/or reduces a probability of dirt particles 63 from entering the vacuum pump 50 through the fluid line 20.

For the threaded bore 12 to be cleaned of dirt particles 63 using the device 10, the vacuum vessel 48 of the illustrated example is first evacuated using the vacuum pump 50, where the shut-off member 54 and the outlet valve 58 are closed. The example shut-off valve 56 is then blocked after the evacuation.

In this example, the cleaning tool 18, via the application portion 26 thereof, is then positioned onto the surface 24 of the workpiece 18 such that the cleaning tool 18 substantially covers the opening 42 of the threaded bore 12, and the end face 44 acts as a connector face bearing in a substantially sealing manner onto the surface 24 of the workpiece 18. The shut-off member 54 of the illustrated example is then abruptly opened and, as a result, negative pressure is generated in the suction chamber 28 as well as the threaded bore 12 communicating therewith. Consequently, ambient air is suctioned/drawn in through the entry opening 40 of the tubular element 34 along the flow direction 64 that is generally indicated by arrows 64.

According to the illustrated example, the fluid duct 38 includes a funnel-shaped port section 39. In this example, the funnel-shaped port section 39 has an effective diameter, D_{F}, of the fluid duct 38 in a generally funnel-shaped manner in a direction generally pointing toward the entry opening 40 that widens to an entry diameter, D_{E}.

The example tubular element 34 directs the suctioned-in ambient air towards the workpiece-side exit opening 65 thereof and the ambient air then subsequently flows into the threaded bore 12. The ambient air in the flow direction, which is generally indicated by arrows 66, is then suctioned through the suction chamber 28 and the fluid line 20 and into the vacuum vessel 48 until the shut-off member 54 is closed. The fluid flow 64 of ambient air, which is provided through the tubular element 34 into the threaded bore 12, is generally coaxial with the flow 66 of the fluid through the threaded bore 12, which is extracted, via suction, from the threaded bore 12. In this example, the fluid flow 64 running in an axis-proximal manner relative to the cylinder axis 46.

In some examples, as the negative pressure in the vacuum vessel 48 drops below a threshold value, the vacuum vessel 48, by way of the suction pump 50, is evacuated again. In particular, in this example, the suction pump 50 of the device 10 may be continuously and/or repeatedly operated. In some examples, suction pump 50 is, preferably, dimensioned such that the negative pressure in the vacuum vessel 48 does not undershoot a threshold value that may be required for efficient cleaning and/or drying, even in examples of successive cleaning and/or drying of a plurality of threaded bores 12.

In some examples, it is also possible that to clean a threaded bore 12, ambient air is suctioned into the threaded bore 12 through the entry opening 40 via the tubular element 34 of the cleaning tool 18 along the flow direction 64 that is generally indicated by arrows 64 until an equilibrium with the ambient air has been generally established in the vacuum vessel 48. Accordingly, the shut-off member 54 of the fluid line 20 is then closed, and the shut-off valve 56 in the fluid line 52 is opened again for the vacuum vessel 48 to be evacuated again. In some examples, the threaded bore 12, in a corresponding manner, may be subject to an additional cleaning process. Alternatively, it is possible for an additional threaded bore to be relieved of dirt particles or remnants of liquid.

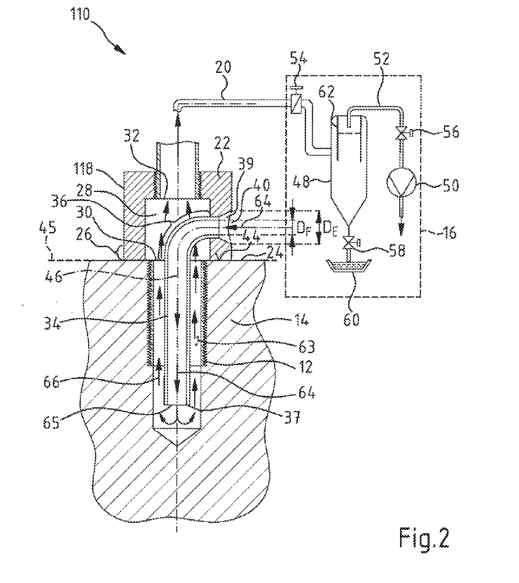

FIG. 2 shows another example device 110 to clean and/or dry a cavity using a second example cleaning tool 118. To the extent that the functional groups of the device 110 shown in FIG. 2, and the elements shown therein correspond to the functional groups and elements of FIG. 1, the same numerals are used as reference signs for identification. The cleaning tool 118 of the illustrated example includes a suction chamber 28 with an extraction opening 32 that is positioned opposite of the suction opening 30. In this example, the tubular-element portion 36 of the tubular element 34, which is disposed in the suction chamber 28, is bent in a relatively arcuate manner.

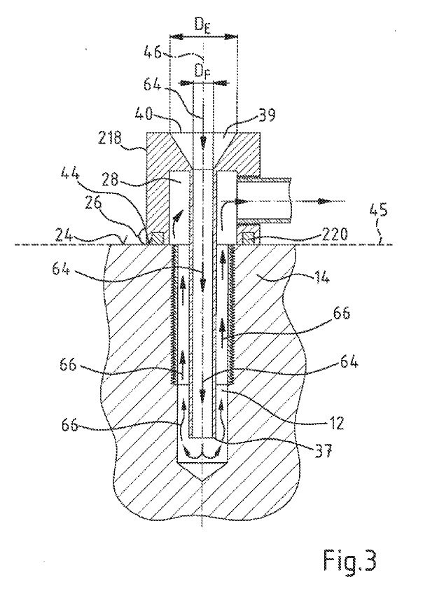

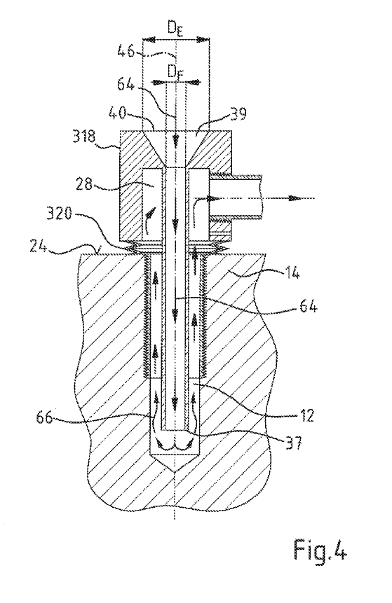

FIG. 3 shows an additional example cleaning tool 218 that may be implemented in a device to clean and/or dry a cavity such as a threaded bore 12 in a workpiece 14, for example. To the extent that the functional groups of the cleaning tool 218 shown in FIG. 4, and the elements shown therein correspond to the functional groups and elements shown in FIG. 1, the same numerals are used as reference signs for identification.

According to the illustrated example of FIG. 3, the cleaning tool 218 has an application portion 26 with an annular sealing element 220 received therein. In the example of the cleaning tool 218, it can be guaranteed by means of the sealing element 220 that the application portion 26 bears in a sealing manner on the surface 24 of the workpiece 14.

FIG. 4 shows an additional example cleaning tool 318 for implementation in a device for cleaning and/or drying a cavity such as a threaded bore 12 in a workpiece 14, for example. To the extent that the functional groups of the cleaning tool 218 shown in FIG. 3, and the elements shown therein correspond to the functional groups and elements shown in FIG. 1, the same numerals are used as reference signs for identification.

The cleaning tool 318 of the illustrated example includes an application portion 26 with a sealing element 320 received therein that is implemented as a bellows, for example. In the example of the cleaning tool 318, it can be guaranteed by the sealing element 220 that the application portion 26 bears in a generally sealing manner on the surface 24 of the workpiece 14, where the sealing manner is between the opening 42 of the cavity 12 and the suction chamber 28.

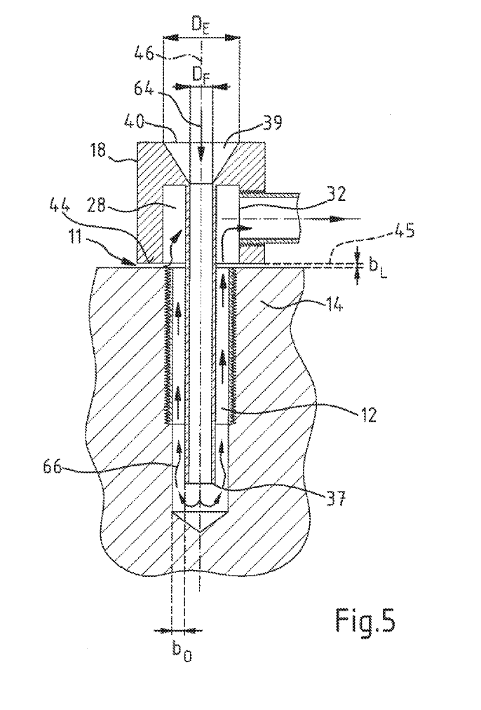

FIG. 5 illustrates cleaning of a threaded bore 12 in a workpiece 14, using the cleaning tool 18 of FIG. 1, which bears on the workpiece 14 in a generally non-contacting manner in this example. In this example, an air space 11 is between the application portion 26 and the surface 24 of the workpiece 14. The width, b_{L}, of the air space 11 of the illustrated example is relatively small so that negative pressure is can be generated in the threaded bore 12 when the suction chamber 28 of the cleaning tool 18 is coupled to the evacuated vacuum vessel 48. According to the illustrated example, the air space for this purpose is significantly smaller than the width, b_{O}, of the opening gap between the tubular element 34 and the wall 35 of the threaded bore (e.g., b_{O}=5 (millimeters) mm and b_{L}=0.5 mm).

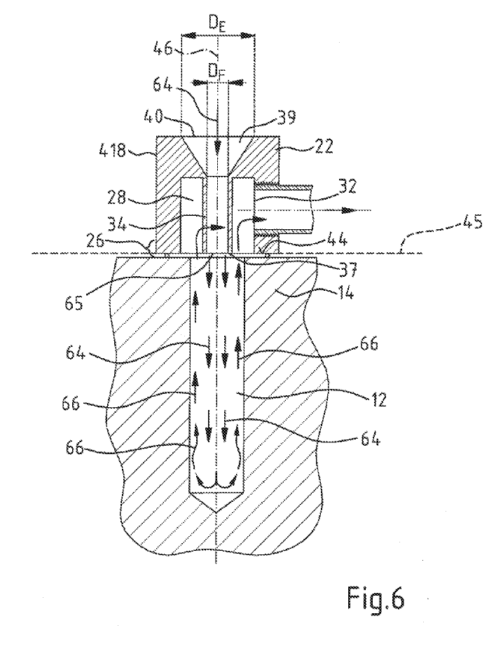

FIG. 6 shows another example cleaning tool 418 that may be implemented in a device to clean and/or dry a threaded bore 12 in a workpiece 14. To the extent that the functional groups of the cleaning tool 418 shown in FIG. 6 and the elements shown therein correspond to the functional groups and elements shown in FIG. 1, the same numerals are used as reference signs for identification.

In the examples related to the cleaning tool 418, the tubular element 34 is disposed in the suction chamber 28. In this example, the tubular element 34 does not protrude into the threaded bore 12 of the workpiece 14. In particular, the tool element 22 of the illustrated example located in or proximate the application portion 26 of the cleaning tool 18 includes a workpiece-side end face 44 with an end-face plane 45, in which the workpiece-side end 37 of the tubular element 34 is disposed.

According to the illustrated example, by applying negative pressure to the extraction opening 32 of the suction chamber 28, ambient air moving along the flow direction 64 that is generally indicated by the arrow flows through the tubular element 34 into the threaded bore 12 relative to cylinder axis 46, which is substantially aligned to the threaded bore 12 and, thus, is axis-proximal. In this example, the ambient air is then extracted by suction through the suction chamber 28 generally along the flow direction 66, which is relatively close to the wall of the threaded bore 12 and generally identified by the arrows.

It should be noted that in an alternative example of the cleaning tool 418, the workpiece-side end 37 of the tubular element 34 is disposed to be recessed relative to the end-face plane 45 of the workpiece-side end face 44.

There beyond, it should be noted that the examples disclosed herein also extend to a device for cleaning and/or drying a cavity, in which combinations of features of the above-described exemplary embodiments are to be found. The aspects described apply in a corresponding manner to the above-described methods for cleaning and/or drying a cavity.

In summary, the following preferred features of the examples disclosed herein are to be noted in particular. The examples disclosed herein relate to a device 10, 110 to clean and/or dry a cavity 12 such as a clearance in a workpiece 14 (e.g., a bore, a threaded bore, etc.) that is accessible via an opening 42. The example device 10, 110 includes an installation 16 to extract by suction, and a cleaning tool 18, 118, 218, 318, 418 with a suction chamber 28 that is connectable/couplable to the installation 16 to extract via suction. The suction chamber 28 has a suction opening 30 for extracting by suction a medium from the cavity 12.

An example device 10 for cleaning and/or drying a cavity 12 such as a clearance in a workpiece 14, for example a bore, in particular, a threaded bore 12, which is accessible through an opening 42, includes an installation 16 for extracting by suction and a cleaning tool 18 that includes a tubular element 34 with a fluid duct 38 for infeeding a cleaning medium into the cavity 12 and has a suction chamber 28 that is connectable to the installation 16 for extracting by suction and which has a suction opening 30 for extracting by suction a medium from the cavity 12 and in which a tubular-element portion 36 of the tubular element 34 is disposed, characterized in that the fluid duct 38 in the tubular-element portion 36 is connected to an entry opening 40 for ambient air, which serves for infeeding a cleaning medium in the form of ambient air into the cavity 12, where the installation for extracting by suction includes a vacuum vessel 48 which is evacuatable by a vacuum pump 50 and has a fluid line 20 which connects the vacuum vessel 48 to the suction chamber 28, in which fluid line 20 a shut-off member 54, configured as a rapid-action switch valve, for shutting-off the fluid line 20 is disposed to selectively connect the vacuum vessel to the suction chamber 23 or to separate the vacuum vessel 48 therefrom.

In some examples, the tubular element 34 extends through the workpiece-side suction opening 30 of the suction chamber 28. In some examples, the tubular element 34 is configured as an immersion pipe which is introducible into the cavity 12 through the opening 42. In some examples, the immersion pipe is length-adjustable. In some examples, the fluid duct 38 has a funnel-shaped port section 39, and/or that the entry opening 40 is configured on a side of the suction chamber 28 that is opposite the workpiece-side suction opening (30). In some examples, the suction chamber 28 is implemented as a cylindrical cavity 12 that is elongated in the general direction of a cylinder axis 46.

In some examples, the tubular element 34 has a tube axis that is substantially aligned with the cylinder axis 46. In some examples, the tubular-element portion 36 in the suction chamber 28 is bent in a generally arcuate manner. In some examples, the cleaning tool 18 has an application portion 26 for engaging across the opening 42 of the cavity 12 in the manner of a suction cup.

In some examples, the suction chamber 28 is configured in a tool element 22 that in the application portion 26 of the cleaning tool 18 has a workpiece-side end face 44 that has an end-face plane 45 and faces a workpiece 14 having a cavity 12 to be cleaned and/or dried, where the tubular element 34 includes a workpiece-side end 37 that lies in the end-face plane 45 or which, in relation to the end-face plane 45, is disposed so as to be recessed. In some examples, the application portion 26 has a sealing means to seal the suction chamber 28 on the workpiece side with a seal that surrounds the opening 42 when the connector portion 26 is placed against the opening 42 of the cavity 12.

In some examples, the sealing means is a sealing element 220, 320 which is received on the application portion 26. In some examples, the sealing element 220, 320 is elastic, and/or the sealing element 320 is flexible, and/or the sealing element 220, 320 is a bellows.

An example method is implemented for cleaning and/or drying a cavity 12 such as a clearance in a workpiece 14, for example a bore, in particular, a threaded bore 12, which is accessible through an opening 42, in which method the cavity 12 is extracted by suction through the opening 42, and in which method a fluid cleaning medium is infed into the cavity 12 during extracting by suction, characterized in that for the pulsated impingement with negative pressure, the cavity 12 is connected to an evacuated vacuum vessel 48.

In some examples, the cleaning medium is infed into the cavity 12 having a fluid flow which runs in the coaxial direction 65 to the flow of the fluid being extracted by suction from the cavity 12, and/or that the cleaning fluid in relation to the axis of the fluid flow of the fluid being extracted by suction from the cavity 12 is infed through the opening 42 of the cavity 12 to the cavity 12 in an axis-proximal manner, and/or that the cleaning fluid is infed through a tubular element 34 which protrudes into the cavity 12, or that the cleaning fluid is infed through a tubular element 34 which is disposed outside the cavity 12; and/or that the cleaning fluid is a gaseous medium, in particular, ambient air.

In some examples, the cavity 12 is extracted by suction through the opening 44, using a cleaning tool 18 that includes a suction chamber 28 that is connected to an installation 16 for extracting by suction through which the dirt particles and/or the liquid accumulated in the cavity 12 are/is routed from the cavity 12 to the installation 16 for extracting by suction. In some examples, for the workpiece-side sealing of the suction chamber 28 the cleaning tool 18 bears in a sealing manner on the workpiece 14, and/or that the cleaning tool 18 during extraction by suction is separated from the workpiece 12 by an air space.

An example device for at least one of cleaning or drying a cavity includes an installation for extracting by suction. The example device also includes a cleaning tool having a tubular element with a fluid duct to provide a cleaning medium into the cavity, the cleaning tool including a suction chamber that is couplable to the installation and a suction opening for extracting by suction a medium from the cavity, in which a tubular-element portion of the tubular element is disposed, wherein the fluid duct in the tubular-element portion is coupled to an entry opening that is to provide a cleaning medium into the cavity, wherein the installation includes a vacuum vessel that is evacuatable by a vacuum pump and has a fluid line that connects the vacuum vessel to the suction chamber, the fluid line having a shut-off member to shut-off the fluid line disposed within to selectively couple the vacuum vessel to the suction chamber or to separate the vacuum vessel therefrom.

In some examples, the cavity includes a bore that is accessible through an opening. In some examples, the cleaning medium includes ambient air. In some examples, the shut-off member includes a rapid action switch valve. In some examples, the tubular element extends through the workpiece-side suction opening of the suction chamber. In some examples, the tubular element includes an immersion pipe that is introducible into the cavity through the opening. In some examples, the immersion pipe is length-adjustable.

In some examples, the fluid duct has a funnel-shaped port section. In some examples, the entry opening is disposed on a side of the suction chamber that is opposite the workpiece-side suction opening. In some examples, the suction chamber is generally shaped as a cylindrical cavity that extends along the direction of a cylinder axis. In some examples, the tubular element includes a tube axis that is substantially aligned with the cylinder axis.

In some examples, the tubular-element portion in the suction chamber is bent in a substantially arcuate manner. In some examples, the cleaning tool includes an application portion for engaging across the opening of the cavity in the manner of a suction cup. In some examples, the suction chamber is in a tool element that, in the application portion of the cleaning tool, has a workpiece-side end face with an end-face plane and faces a workpiece having a cavity to be at least one of cleaned or dried, where the tubular element has a workpiece-side end that lies in the end-face plane or is disposed to be recessed relative to the end-face plane. In some examples, the application portion has a sealing means, so as to seal the suction chamber on the workpiece side with a seal which surrounds the opening when the connector portion is placed against the opening of the cavity. In some examples, the sealing means includes a sealing element which is received on the application portion. In some examples, the sealing element is a bellows.

An example method is implemented for at least one of cleaning or drying a cavity in a workpiece that is accessible through an opening, where the cavity is extracted by suction through the opening, where a fluid cleaning medium is provided into the cavity during extracting by suction, and where for pulsated impingement with negative pressure, the cavity is coupled to an evacuated vacuum vessel.

In some examples, the example method includes at least one of the cleaning medium is provided into the cavity having a fluid flow that runs generally along the coaxial direction to the flow of the fluid being extracted by suction from the cavity, the cleaning fluid in relation to the axis of the fluid flow of the fluid being extracted by suction from the cavity is provided through the opening of the cavity to the cavity in an axis-proximal manner, the cleaning fluid is provided through a tubular element that protrudes into the cavity, the cleaning fluid is provided through a tubular element that is disposed outside the cavity, or the cleaning fluid is a gaseous medium.

In some examples, the gaseous medium is ambient air. In some examples, at least one of: the cavity is extracted by suction through the opening, via a cleaning tool that includes a suction chamber that is coupled to an installation for extracting by suction through which the dirt particles, or the liquid accumulated in the cavity are to be routed from the cavity to the installation for extracting via suction. In some examples, for the workpiece-side sealing of the suction chamber, the cleaning tool bears in a substantially sealing manner onto the workpiece. In some examples, the cleaning tool during extraction by suction is separated from the workpiece by an air space.

An example tool apparatus for cleaning cavity includes an inner tube to provide a fluid to the cavity when the tool apparatus is positioned relative to the cavity, and an annular tube surrounding the inner tube, where the annular tube fluidly coupled to a suction chamber and where the suction chamber fluidly coupled to a vacuum vessel. The example tool apparatus also includes a valve disposed between the suction chamber and the vacuum vessel.

In some examples, the inner tube is to be placed into the cavity. In some examples, the annular tube is to be placed into the cavity. In some examples, the fluid is ambient air. In some examples, the cavity is a machined bore.

This patent arises as a continuation-in-part of International Patent Application No. PCT/EP2015/064908, which was filed on Jun. 30, 2015, which claims priority to German Patent Application No. 10 2014 213 089, which was filed on Jul. 4, 2014. The foregoing International Patent Application and German Patent Application are hereby incorporated herein by reference in their entireties.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A device for at least one of cleaning or drying a cavity, comprising:
an installation for extracting by suction; and
a cleaning tool having a tubular element with a fluid duct to provide a cleaning medium into the cavity, the cleaning tool including a suction chamber that is couplable to the installation and a suction opening for extracting by suction a medium from the cavity, in which a tubular-element portion of the tubular element is disposed, wherein the fluid duct in the tubular-element portion is coupled to an entry opening that is to provide a cleaning medium into the cavity, wherein the installation includes a vacuum vessel that is evacuatable by a vacuum pump and has a fluid line that connects the vacuum vessel to the suction chamber, the fluid line having a shut-off member to shut-off the fluid line disposed within to selectively couple the vacuum vessel to the suction chamber or to separate the vacuum vessel therefrom.

2. The device as defined in claim 1, wherein the cavity includes a bore that is accessible through an opening.

3. The device as defined in claim 1, wherein the cleaning medium includes ambient air.

4. The device as defined in claim 1, wherein the shut-off member includes a rapid action switch valve.

5. The device as defined in claim 1, wherein the tubular element extends through the workpiece-side suction opening of the suction chamber.

6. A device as defined in claim 1, wherein the tubular element includes an immersion pipe that is introducible into the cavity through the opening.

7. The device as defined in claim 6, wherein the immersion pipe is length-adjustable.

8. The device as defined in claim 1, wherein the fluid duct has a funnel-shaped port section.

9. The device as defined in claim 1, wherein the entry opening is disposed on a side of the suction chamber that is opposite the workpiece-side suction opening.

10. The device as defined in claim 1, wherein the suction chamber is generally shaped as a cylindrical cavity that extends along the direction of a cylinder axis.

11. The device as defined in claim 10, wherein the tubular element includes a tube axis that is substantially aligned with the cylinder axis.

12. The device as defined in claim 1, wherein the tubular-element portion in the suction chamber is bent in a substantially arcuate manner.

13. The device as defined in claim 1, wherein the cleaning tool includes an application portion for engaging across the opening of the cavity in the manner of a suction cup.

14. The device as defined in claim 13, wherein the suction chamber is in a tool element that, in the application portion of the cleaning tool, has a workpiece-side end face with an end-face plane and faces a workpiece having a cavity to be at least one of cleaned or dried, the tubular element having a workpiece-side end that lies in the end-face plane or is disposed to be recessed relative to the end-face plane.

15. The device as defined in claim 13, wherein the application portion has a sealing means, so as to seal the suction chamber on the workpiece side with a seal which surrounds the opening when the connector portion is placed against the opening of the cavity.

16. The device as defined in claim 15, wherein the sealing means includes a sealing element which is received on the application portion.

17. The device as defined in claim 16, wherein the sealing element is a bellows.

18. A method for at least one of cleaning or drying a cavity in a workpiece that is accessible through an opening, wherein the cavity is extracted by suction through the opening, wherein a fluid cleaning medium is provided into the cavity during extracting by suction, and
wherein for pulsated impingement with negative pressure, the cavity is coupled to an evacuated vacuum vessel.

19. The method as defined in claim 18, wherein at least one of:
the cleaning medium is provided into the cavity having a fluid flow that runs generally along the coaxial direction to the flow of the fluid being extracted by suction from the cavity;
the cleaning fluid in relation to the axis of the fluid flow of the fluid being extracted by suction from the cavity is provided through the opening of the cavity to the cavity in an axis-proximal manner, or
the cleaning fluid is provided through a tubular element that protrudes into the cavity;
the cleaning fluid is provided through a tubular element that is disposed outside the cavity; or
the cleaning fluid is a gaseous medium.

20. The method as defined in claim 19, wherein the gaseous medium is ambient air.

21. The method as defined in claim 19, wherein at least one of:
the cavity is extracted by suction through the opening, via a cleaning tool that includes a suction chamber that is coupled to an installation for extracting by suction through which the dirt particles; or
the liquid accumulated in the cavity are to be routed from the cavity to the installation for extracting via suction.

22. The method as defined in claim 19, wherein for the workpiece-side sealing of the suction chamber, the cleaning tool bears in a substantially sealing manner onto the workpiece.

23. The method as defined in claim 19, wherein the cleaning tool during extraction by suction is separated from the workpiece by an air space.

24. A tool apparatus for cleaning a cavity comprising:
an inner tube to provide a fluid to the cavity when the tool apparatus is positioned relative to the cavity;
an annular tube surrounding the inner tube, the annular tube fluidly coupled to a suction chamber, the suction chamber fluidly coupled to a vacuum vessel; and
a valve disposed between the suction chamber and the vacuum vessel.

25. The tool apparatus as defined in claim 24, wherein the inner tube is to be placed into the cavity.

26. The tool apparatus as defined in claim 25, wherein the annular tube is to be placed into the cavity.

27. The tool apparatus as defined in claim 24, wherein the fluid is ambient air.

28. The tool apparatus as defined in claim 24, wherein the cavity is a machined bore.
